(19) United States
(12) Patent Application Publication
(10) Pub. No.: US 2017/0133122 A1
(43) Pub. Date: May 11, 2017

(54) Wire Harness

(71) Applicant: YAZAKI Corporation, Minato-ku, Tokyo (JP)

(72) Inventor: Naonari UCHIDA, Susono-shi (JP)

(73) Assignee: Yazaki Corporation, Minato-ku, Tokyo (JP)

(21) Appl. No.: 15/322,952

(22) PCT Filed: Jul. 30, 2015
(86) PCT No.: PCT/JP2015/071728

§ 371 Date: Dec. 29, 2016

(30) Foreign Application Priority Data
Aug. 1, 2014 (JP) 2014-157656

(51) Int. Cl. H01B 7/00; H01B 3/44; H01B 1/02

(52) U.S. Cl. CPC H01B 7/0045; H01B 1/023; H01B 3/448; H01B 3/441

(57) ABSTRACT

In a wire harness (1) to be used in a place where a temperature of a use environment is 100° C. or higher, at least one electric wire of a plurality of electric wires (10) is an aluminum electric wire (11) including a conductor core wire formed from pure aluminum or an aluminum alloy. The aluminum electric wire (11) is covered with a foamed body (20).

### TECHNICAL FIELD

The present invention relates to wire harnesses.

### BACKGROUND ART

A wire harness in which a plurality of electric wires is bundled as a collective component has been proposed in the background art. In recent years, it has been proposed to use electric wires using aluminum (aluminum electric wires) as conductors in a wire harness from a viewpoint of reduction in weight and reduction in cost.

For example, in one of aluminum electric wires in the background art (hereinafter referred to as “background-art electric wire”), pure aluminum or an aluminum alloy is used as a conductor core wire of the electric wire in place of conventional copper. In addition, a 1000-series or 6000-series aluminum alloy according to JIS Standard is typically used as the aluminum alloy for use in such an application.

### CITATION LIST

### Patent Literature

Patent Literature 1: JP 2011-252185 A

### SUMMARY OF THE INVENTION

### Problems to be Solved by the Invention

However, when a wire harness using background-art electric wires is arranged in an engine room and a roof of a car (that is, in a place where the temperature of a use environment may be 100° C. or higher), there is a possibility that conductor core wires are softened due to the temperature of the use environment so that the strength of the conductor core wires (and hence the strength of the wire harness) may decrease.

In consideration of the aforementioned problem, an object of the invention is to provide a wire harness capable of suppressing softening of conductor core wires of aluminum electric wires under a high temperature environment.

### Means for Solving the Problem

In order to attain the foregoing object, wire harnesses according to the invention are characterized by the following items (1) to (7).

(1)

A wire harness comprising a plurality of electric wires, the wire harness being used in a place where a temperature of a use environment is 100° C. or higher,

at least one electric wire of the plurality of electric wires being an aluminum electric wire including a conductor core wire formed from pure aluminum or an aluminum alloy,

the aluminum electric wire being covered with a foamed body.

(2)

The wire harness according to item (1), wherein

the foamed body has a thermal conductivity of 0.058 W/m·K or less.

(3)

The wire harness according to item (1) or item (2), wherein

the foamed body has a thickness from 2 mm to 6 mm.

(4)

The wire harness according to item (3), wherein

the foamed body has a thickness from 2 mm to 5 mm.

(5)

The wire harness according to item (3), wherein:

the foamed body has a thickness more than 5 mm and not more than 6 mm.

(6)

The wire harness according to any one of item (1) to item (5), wherein

the foamed body is made from foamed polyvinyl chloride when the aluminum electric wire includes an insulator made from polyvinyl chloride, and the foamed body is made from foamed polyethylene when the aluminum electric wire includes the insulator made from polypropylene.

(7)

The wire harness according to any one of item (1) to item (6), wherein

the foamed body has a layer structure including at least one layer of a closed cell structure having its internal cells being independent of one another.

According to the wire harness having the aforementioned item (1), the foamed body is provided around the aluminum electric wire (electric wire whose conductor core wire is of aluminum or an aluminum electric wire). Accordingly, the temperature of the use environment (thermal energy) is hardly transmitted to the conductor core wire due to the heat shielding effect of the foamed body so that softening of the conductor core wire can be suppressed. As a result, it is possible to suppress softening of the conductor core wire of the aluminum electric wire under the high-temperature environment.

In addition, the foamed body may be provided to cover the aluminum electric wire directly or indirectly. The foamed body does not have to be always provided in direct tight contact with only the aluminum electric wire. For example, the foamed body may be provided to cover only the circumference of the aluminum electric wire while the foamed body is not provided around the other electric wires, or the foamed body may be provided to cover the circumference of a plurality of electric wires including the aluminum electric wire.

According to the wire harness having the aforementioned item (2), the thermal conductivity of the foamed body is so low that the temperature of the use environment (thermal energy) can be more surely suppressed from being transmitted to the conductor core wire. Specifically, according to experiments and considerations of the inventor, it has been proved that when an electric wire is covered with a foamed body having a thermal conductivity of 0.058 W/m·K or lower, defects such as disconnection and deterioration in vibration resistance caused by reduction in conductor breaking strength of a conductor core wire of the electric wire can be effectively prevented in a generally expected use state of a wire harness. Thus, in the wire harness having this item, the thermal conductivity of the foamed body is made 0.058 W/m·K or lower.

According to the wire harness having the aforementioned item (3), the foamed body is so thick that the temperature of the use environment (thermal energy) can be more surely suppressed from being transmitted to the conductor core wire. Specifically, according to experiments and considerations of the inventor, it has been proved that when the thickness of a foamed body is not less than 2 mm, softening of a conductor core wire of an electric wire can be effectively prevented in a generally expected use state of a wire harness. Thus, in the wire harness having this item, the thickness of the foamed body is made not less than 2 mm. On the other hand, according to experiments and considerations of the inventor, it has been proved that when the thickness of a foamed body is beyond 6 mm, the heat insulating effect of the foamed body cannot increase so much even if the thickness of the foamed body is increased. That is, it has been proved that the heat insulating effect reaches saturation in practical use. Thus, in the wire harness having this item, the thickness of the foamed body is made not more than 6 mm.

For example, when the foamed body is a foamed sheet wound around a plurality of electric wires, the sheet thickness of the foamed body may be made not less than 2 mm and not more than 6 mm. On the other hand, when the foamed body is a formed body that is formed directly around a plurality of electric wires, the foamed body may be formed so that the thickness of the foamed body between a virtual plane circumscribing the electric wires and the outside air can be put within a range not less than 2 mm and not more than 6 mm.

According to the wire harness having the aforementioned item (4), flexibility can be secured in the wire harness. Specifically, according to experiments and considerations of the inventor, it has been proved that when the thickness of a foamed body is not more than 5 mm, a wire harness can have enough flexibility to arrange the wire harness in a car or the like. Thus, in the wire harness having this item, the thickness of the foamed body is made not less than 2 mm and not more than 5 mm.

According to the wire harness having the aforementioned item (5), the shape of the wire harness can be restricted by the foamed body itself. Specifically, it has been proved that when the thickness of the foamed body is beyond 5 mm and the foamed body is processed into a predetermined shape, the route of the wire harness can be restricted without separately providing another member for restricting the route of the wire harness. Thus, the working efficiency in the arrangement of the wire harness can be enhanced. It has been made obvious that the wire harness can have enough flexibility to arrange the wire harness in a car or the like. Thus, in the wire harness having the present invention, the thickness of the foamed body is made not less than 2 mm and not more than 5 mm. Thus, in the wire harness having the present invention, the thickness of the foamed body is made more than 5 mm and not more than 6 mm.

According to the wire harness having the aforementioned item (6), deterioration of the insulator caused by dehydrochlorination reaction can be suppressed, as compared with a case where the insulator made from an organochlorine compound is exposed directly to the outside air.

According to the wire harness having the aforementioned item (7), the temperature of the use environment (thermal energy) is hardly transmitted to the conductor core wire, as compared with a case where cells are coupled with one another. It is possible to more surely suppress softening of the conductor core wire of the aluminum electric wire under the high-temperature environment.

### Advantage of the Invention

According to the invention, it is possible to provide a wire harness capable of suppressing softening of a conductor core wire of an aluminum electric wire under a high temperature environment.

### BRIEF DESCRIPTION OF THE DRAWINGS

FIG. 1 is a top view schematically showing a wire harness according to an embodiment of the invention.

FIG. 2 is a schematic view showing a section of the wire harness shown in FIG. 1.

FIG. 3 is a schematic view showing a section of a wire harness according to a first modification of the embodiment.

FIG. 4 is a schematic view showing a section of a wire harness according to a second modification of the embodiment.

### MODE FOR CARRYING OUT THE INVENTION

A wire harness 1 according to an embodiment of the invention will be described below with reference to the drawings.

### <Structure of Wire Harness>

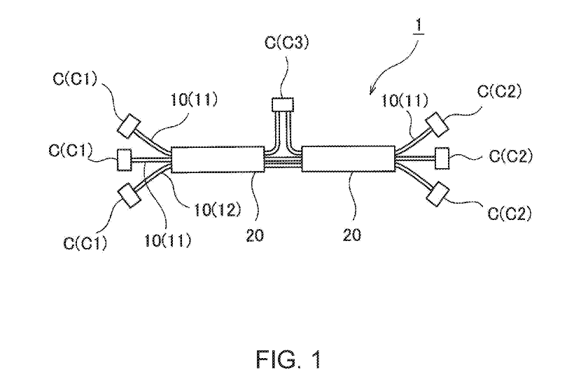

As shown in FIG. 1, the wire harness 1 is a collective component in which a plurality of electric wires 10 have been bundled. The wire harness 1 may be used in a place where the temperature of a use environment may be 100° C. or higher (such as an engine room, a roof, etc. in a car, where the temperature may reach such a temperature or higher in summer etc.).

The wire harness 1 includes the electric wires 10, connectors C, and a foamed body 20. Of the electric wires 10, at least one electric wire 11 is an aluminum electric wire whose conductor core wire is formed from pure aluminum or an aluminum alloy. The other electric wires 12 are copper electric wires whose conductor core wires are formed from pure copper or a copper alloy. In FIGS. 1 to 4, the reference numeral 11 is added to each aluminum electric wire, and the reference numeral 12 is added to each copper electric wire.

In addition, each electric wire 10 (particularly each aluminum electric wire 11) does not have to be constituted only by a conductor core wire and an insulator. For example, a tension member may be prepared for a plurality of electric wires 10 so that the electric wires 10 can be provided around the tension member. The electric wires 10 may be compressed together with the tension member. In addition, the configuration may be arranged so that a plurality of tension members and a plurality of electric wires 10 can be mixed. In addition, a material close to aluminum as to natural electric potential and high in strength, such as SUS (stainless steel) or iron, is preferable for the tension members.

The connectors C are provided in end parts of the electric wires 10 respectively so as to serve as connection parts to other devices. The connectors C include a first connector group C1 provided at one end of the wire harness 1, a second connector group C2 provided at the other end of the wire harness 1, and an intermediate connector group C3 (including only one connector C3 in FIG. 1 though it is referred to as connector group) provided in end portions of electric wires 10 extracted from an intermediate part of the wire harness 1.

The foamed body 20 is made from a material low in thermal conductivity, and provided around the electric wires 10 so as to cover the electric wires 10. The electric wires 10 are bundled by the foamed body 20. In addition, in the embodiment, the electric wires 10 are bundled not only by the foamed body 20 but also by an adhesive tape or the like.

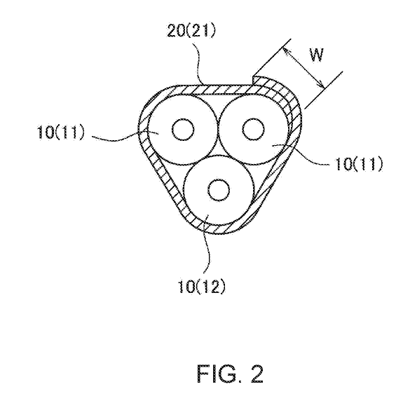

As shown in the sectional view of FIG. 2, the foamed body 20 is constituted by a foamed sheet 21 having an adhesive layer on its one surface. The foamed sheet 21 is wound so that the adhesive layer can face the electric wires 10. The foamed sheet 21 is provided around the electric wires 10 so that pieces of the foamed sheet 21 can be overlaid on each other in a part W thereof.

As shown in FIG. 1, the wire harness 1 includes the intermediate connector group C3 according to the embodiment. Therefore, the foamed body 20 (foamed sheet 21) is wound between the first connector group C1 and the intermediate connector group C3 and between the intermediate connector group C3 and the second connector group C2.

In the embodiment, a sheet material lower in thermal conductivity than the insulators of the electric wires 10 (particularly the insulators of the aluminum electric wires 11) is used as the foamed sheet 21. Specifically, a sheet material whose thermal conductivity is not higher than 0.058 W/m·K is used as the foamed sheet 21. The thermal conductivity of the foamed sheet 21 is not higher than about ⅓ of the thermal conductivity of PVC (polyvinyl chloride) or PP (polypropylene), which is generally used as an insulator. In this manner, it is possible to suitably prevent the conductor core wires of the aluminum electric wires 11 from being softened under a high temperature environment.

Further, as the material of the foamed sheet 21, it is preferable to use a material whose thermal conductivity is not higher than 0.034 W/m·K (such as foamed polyethylene), and it is more preferable to use a material whose thermal conductivity is not higher than 0.026 W/m·K (such as foamed PVC). It is further more preferable to use a material whose thermal conductivity is not higher than 0.025 W/m·K (such as foamed urethane). When such a material is used, it is possible to more surely prevent conductor core wires of aluminum electric wires from being softened.

For example, when PVC is used for the insulators of the aluminum electric wires 11, it is preferable that the foamed sheet 21 is made from foamed polyvinyl chloride. On the other hand, when PP is used for the insulators of the aluminum electric wires, it is preferable that the foamed sheet 21 is made from foamed polyethylene. In this manner, deterioration of the insulators caused by dehydrochlorination reaction can be suppressed.

Further, it is preferable that the foamed sheet 21 has a closed cell structure in which internal cells are formed to be independent of one another. Thus, the temperature of the use environment (thermal energy) is hardly transmitted to the conductor core wires, as compared with a case where cells are coupled with one another. In addition, the foamed sheet 21 may have a structure in which two or more layers of foamed body structures are overlaid on each other. When the structure in which two or more layers of foamed body structures are overlaid on each other is provided, it will go well if at least one of the layers has a closed cell structure.

### <Evaluation of Wire Harness>

Next, Examples of the wire harness 1 according to the embodiment and Comparative examples will be described. Table 1 shows properties of Examples 1 to 3 and Comparative examples 1 to 3.

TABLE 1

| | | | Electric wire surface | | |
|---|---|---|---|---|---|
| | | | temperature | | |
| | | | | 5 min later | |
| | Thickness of | Flexibility | | at 120° C. | |
| | foamed sheet | (mountability) | Initial | atmosphere | |
| Comparative | — | A | 20° C. | C | |
| Example 1 | | | | 110° | C. |
| Comparative | 1 mm | A | 20° C. | C | |
| Example 2 | | | | 108° | C. |
| Example 1 | 2 mm | A | 20° C. | A | |
| | | | | 88° | C. |
| Example 2 | 5 mm | B | 20° C. | A | |
| | | | | 81° | C. |
| Example 3 | 6 mm | C | 20° C. | A | |
| | | | | 78° | C. |
| Comparative | 7 mm | C | 20° C. | C | |
| Example 3 | | | | 77° | C. |

Each of wire harnesses in Examples 1 to 3 and Comparative examples 2 and 3 was formed as follows. That is, ten aluminum electric wires and ten copper electric wires were bundled into one, and a foamed sheet made from foamed polyethylene was wound around the bundle. The wire harnesses in Examples 1 to 3 and Comparative examples 2 and 3 differed from one another as to the thicknesses of their foamed sheets. Specifically, the thicknesses of the foamed sheets were set at 1 mm, 2 mm, 5 mm, 6 mm and 7 mm respectively (overlapping parts were made as small as possible in order to make the influence of the same parts as small as possible). The wire harness in Comparative example 1 was a wire harness constituted only by electric wires formed in the same manner as in Examples 1 to 3 and Comparative examples 2 and 3.

Table 1 shows temperatures in the electric wire surfaces immediately after the wire harnesses were put into a thermostatic tank at 120° C., and temperatures in the electric wire surfaces 5 minutes later after the wire harnesses were put into the thermostatic tank.

As for criteria to evaluate the temperature of each electric wire surface, the temperature of the electric wire surface was evaluated as “C” when it was not lower than 90° C., and as “A” when it was lower than 90° C.

As for criteria to evaluate flexibility (mountability) of each wire harness, the wire harness was evaluated as “A” when it was bent easily and could not easily return to its original shape, as “B” when it could be bent with some force and returned to its original shape, and as “C” when it was too hard to be bent and, even if bent, returned to its original shape immediately.

As a result of the evaluation, Comparative example 1 (with no foamed sheet) was evaluated as “A” about the flexibility and “C” about the electric wire surface temperature (5 minutes later at 120° C. atmosphere).

Comparative example 2 (with foamed sheet 1 mm thick) was evaluated as “A” about the flexibility and “C” about the electric wire surface temperature.

Example 1 (with foamed sheet 2 mm thick) was evaluated as “A” about the flexibility and also “A” about the electric wire surface temperature.

Example 2 (with foamed sheet 5 mm thick) was evaluated as “B” about the flexibility and also “A” about the electric wire surface temperature.

Example 3 (with foamed sheet 6 mm thick) was evaluated as “C” about the flexibility and “A” about the electric wire surface temperature.

Comparative example 3 (with foamed sheet 7 mm thick) was evaluated as “C” about the flexibility and “A” about the electric wire surface temperature.

In this manner, from the viewpoint of electric wire surface temperature, it was proved that it is preferable that the thickness of the foamed sheet is not less than 2 mm and not more than 6 mm. To say other words, it was proved that when the thickness of the foamed sheet is not less than 2 mm, the state that the electric wire surface temperature is below 90° C. can be kept even if the wire harness is exposed to a high temperature environment (120° C.). Further, it was proved that when the thickness of the foamed sheet is beyond 6 mm, the heat shielding effect cannot be enhanced so much even if the thickness of the foamed sheet increases.

Further, from the viewpoint of flexibility, it was proved that it is preferable that the thickness of the foamed sheet is not less than 2 mm and not more than 5 mm. Specifically, when the thickness of the foamed sheet is beyond 5 mm, the part where the foamed sheet is placed cannot be bent easily. Thus, the working efficiency in arranging the wire harness deteriorates.

In addition, from the viewpoint of restriction of the route of the wire harness, it was proved that it is preferable that the thickness of the foamed sheet is more than 5 mm and not more than 6 mm. To say other words, when the thickness of the foamed sheet is beyond 5 mm, it was proved that rigidity increases in the part where the foamed sheet is provided, and the route of the wire harness can be restricted when the foamed sheet is provided around the electric wires and in a predetermined shape or the like.

Table 2 shows properties of wire harnesses 1 in Examples 4 to 7 and Comparative examples 4 to 6.

TABLE 2

| | | | Electric wire surface | | |
|---|---|---|---|---|---|
| | | | temperature | | |
| | | Foamed | | 5 min later | |
| | Insulating | structure of | | at 120° C. | |
| | material | foamed sheet | Initial | atmosphere | |
| Comparative | PVC | nothing | 20° C. | C | |
| Example 4 | | | | 110° | C. |
| Comparative | PVC | continuous cell | 20° C. | B | |
| Example 5 | | structure | | 91° | C. |
| Example 4 | PVC | closed cell | 20° C. | A | |
| | | structure | | 70° | C. |
| Example 5 | PVC | continuous and | 20° C. | A | |
| | | closed cell | | 81° | C. |
| | | structure | | | |
| Comparative | PP | continuous cell | 20° C. | B | |
| Example 6 | | structure | | 89° | C. |

| | | | | |
|---|---|---|---|---|
| Example 6 | PP | closed cell | 20° C. | A |

| | | |
|---|---|---|
| structure | 67° | C. |

| | | | | |
|---|---|---|---|---|
| Example 7 | PP | continuous and | 20° C. | A |

| | | |
|---|---|---|
| closed cell | 80° | C. |
| structure | | |

Each of wire harnesses in Examples 4 to 7 and Comparative examples 5 and 9 was formed as follows. That is, ten aluminum electric wires and ten copper electric wires were bundled into one, and a foamed sheet made from foamed polyethylene was wound around the bundle. The wire harnesses in Examples 4 and 5 and Comparative examples 4 and 5 used PVC as their insulators. The form sheet in Comparative example 5 had a continuous cell structure. The form sheet in Example 4 had a closed cell structure. The form sheet in Example 4 had a two-layer structure including a continuous cell structure and a closed cell structure. The wire harnesses in Examples 6 and 7 and Comparative example 6 used PP as their insulators. The form sheet in Comparative example 6 had a continuous cell structure. The form sheet in Example 6 had a closed cell structure. The form sheet in Example 7 had a two-layer structure including a continuous cell structure and a closed cell structure.

Table 2 shows temperatures in the electric wire surfaces immediately after the wire harnesses were put into a thermostatic tank at 120° C., and temperatures in the electric wire surfaces 5 minutes later after the wire harnesses were put into the thermostatic tank.

As for criteria to evaluate the temperature of each electric wire surface, the temperature of the electric wire surface was evaluated as “A” when it was lower than 89° C., as “B” when it was around 90° C. (not lower than 89° C. and not higher than 91° C.), and as “C” when it was beyond 91° C.

As a result of the evaluation, Comparative example 4 (with no foamed sheet) was evaluated as “C” about the electric wire surface temperature (5 minutes later at 120° C. atmosphere).

Comparative example 5 (with foamed sheet having continuous cell structure) was evaluated as “B” about the electric wire surface temperature.

Example 4 (with foamed sheet having closed cell structure) was evaluated as “A” about the electric wire surface temperature.

Example 5 (with foamed sheet having two-layer structure including continuous cell structure and closed cell structure) was evaluated as “A” about the electric wire surface temperature.

Comparative example 6 (with foamed sheet having continuous cell structure) was evaluated as “B” about the electric wire surface temperature.

Example 6 (with foamed sheet having closed cell structure) was evaluated as “A” about the electric wire surface temperature.

Example 7 (with foamed sheet having two-layer structure including continuous cell structure and closed cell structure) was evaluated as “B” about the electric wire surface temperature.

In this manner, from the viewpoint of temperature, it was proved that it is preferable to use a foamed sheet having a single-layer structure of a closed cell structure or a foamed sheet having a two-layer structure including a continuous cell structure and a closed cell structure, and it is most preferable to use a foamed sheet having a single-layer structure of a closed cell structure. In addition, from the aforementioned result, it can be estimated that a foamed sheet having a multilayer structure having three or more layers including at least one layer of a closed cell structure is more preferable than a foamed sheet having a single-layer structure of a continuous cell structure.

Further, a similar result could be observed if the insulators of electric wires are formed from either PVC or PP. However, it was proved that the electric wire surface temperature in a case where an insulator formed from PP is used is a little lower than in a case where an insulator formed from PVC.

### <Modifications>

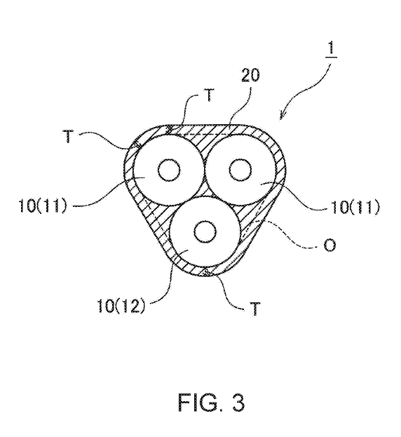

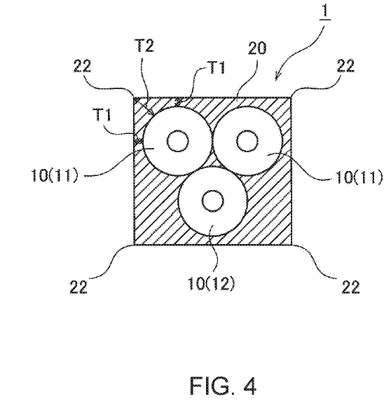

Next, modifications of the wire harness 1 will be described with reference to FIGS. 3 and 4. As shown in FIG. 3, the foamed body 20 is not limited to the foamed sheet 21, but the foamed body 20 may be formed directly around the electric wires 10. In this case, the form 20 is formed directly by extrusion molding or the like.

In the wire harness 1 according to a first modification, the foamed body 20 has a substantially uniform thickness T between a virtual plane O circumscribing the electric wires 10 and the outside air. An effect similar to the aforementioned effect can be obtained when the thickness T is set at the same value as the examples shown in Table 1 (for example, when the thickness T is made not less than 2 mm and not more than 6 mm).

Further, since the foamed body 20 is formed directly around the electric wires 10 and 11 by extrusion molding, mold forming or the like according to the first modification, the foamed body 20 in the part which will be bent when the wire harness 1 is arranged and wired can be formed to be thin (for example, not less than 2 mm thick and not more than 5 mm thick), and the foamed body 20 in the part which will restrict the route can be formed to be thick (for example, not less than 5 mm thick and not more than 6 mm thick). With such a configuration, it is possible to suppress softening of conductor core wires of aluminum electric wires 11 in a single wire harness 1 while a part which should be bent and a part whose route should be restricted can be distinguished in the same wire harness 1.

Further, as shown in FIG. 3, since the foamed body 20 is formed directly around the electric wires 10, the foamed body 20 can be provided continuously by extrusion molding, mold forming or the like, for example, between the first connector group C1 and the second connector ground C2 even if the intermediate connector group C3 is provided therebetween. Thus, it is possible to prevent such a situation that the foamed body 20 to be provided is absent from the root of the intermediate connector group C3.

Preferably the foamed body 20 has a closed cell structure (or a multilayer structure including at least one layer of a closed cell structure) as shown in Table 2.

FIG. 4 is a sectional view of a wire harness 1 according to a second modification of the embodiment. As shown in FIG. 4, the foamed body 20 may be formed directly around the electric wires 10 by extrusion molding, mold forming or the like. According to the second modification, the foamed body 20 has a polygonal (quadrangular) sectional shape with corner portions 22. As a result, even when a thinnest part (thickness T1) is, for example, 2 mm thick, a thicker part (thickness T2) is formed to enhance the rigidity of each corner portion 22. Thus, it is possible to provide the wire harness 1 suitable for restricting its route.

In addition, when the wire harness according to the second modification is evaluated on the evaluation criteria shown in Table 1, it is evaluated as “C” about flexibility independently of the thickness of the foamed sheet due to the corner portions 22 belonging to the foamed body 20 according to the second modification. On the other hand, it has a tendency that the electric wire surface temperature is slightly reduced due to the existence of the thicker part (thickness T2).

As has been described above, in the wire harness 1 according to the embodiment, the conductor core wires of the aluminum electric wires 11 are made from pure aluminum or an aluminum alloy, and the foamed body 20 is provided around the electric wires 10 to bundle the electric wires 10 into one. Thus, the temperature of the use environment (thermal energy) is blocked by the foamed body 20 so that the temperature cannot be transmitted to the conductor core wires easily but softening of the conductor core wires can be suppressed. It is therefore possible to suppress softening of the conductor core wires of the aluminum electric wires 11 under a high temperature environment.

Although the invention has been described in detail and with reference to its specific embodiment, it is obvious for those skilled in the art that various changes or modifications can be made on the invention without departing the spirit and scope of the invention.

For example, the wire harness 1 according to the embodiment includes the aluminum electric wires 11 and the copper electric wires 12, and the foamed body 20 is provided around the electric wires. However, a wire harness according to the invention may be arranged to include only aluminum electric wires 11 and provide a form 20 around the aluminum electric wires 11.

Further, in order to prevent softening of conductor core wires (copper) in copper electric wires 12, a wire harness according to the invention may be arranged to provide a form 20 around the copper electric wires 12.

Here, the aforementioned features of the embodiment of the wire harness according to the invention will be summarized and listed briefly as follows.

(1)

A wire harness (1) comprising a plurality of electric wires (10), the wire harness being used in a place where a temperature of a use environment is 100° C. or higher,

at least one electric wire of the plurality of electric wires being an aluminum electric wire (11) including a conductor core wire formed from pure aluminum or an aluminum alloy,

the aluminum electric wire (11) being covered with a foamed body (20).

(2)

The wire harness according to item (1), wherein

the foamed body (20) has a thermal conductivity of 0.058 W/m·K or less.

(3)

The wire harness according to item (1) or item (2), wherein

the foamed body (20) has a thickness from 2 mm to 6 mm.

(4)

The wire harness according to item (3), wherein

the foamed body (20) has a thickness from 2 mm to 5 mm.

(5)

The wire harness according to item (3), wherein:

the foamed body (20) has a thickness more than 5 mm and not more than 6 mm.

(6)

The wire harness according to any one of item (1) to item (5) wherein

the foamed body (20) is made from foamed polyvinyl chloride when the aluminum electric wire (11) includes an insulator made from polyvinyl chloride, and the foamed body (10) is made from foamed polyethylene when the aluminum electric wire (11) includes the insulator made from polypropylene.

(7)

The wire harness according to any one of item (1) to item (6), wherein

the foamed body (20) has a layer structure including at least one layer of a closed cell structure having its internal cells being independent of one another.

The present application is based on a Japanese patent application (Japanese Patent Application No. 2014-157656) filed on Aug. 1, 2014, the contents of which are incorporated herein by reference.

### INDUSTRIAL APPLICABILITY

According to the invention, it is possible to suppress softening of a conductor core wire of an aluminum electric wire under a high temperature environment. The invention having the effect is useful for a wire harness.

### DESCRIPTION OF REFERENCE NUMERALS AND SIGNS

1: wire harness
10: plural electric wires
11: aluminum electric wire
12: copper electric wire
20: foamed body
21: foamed sheet

1. A wire harness comprising a plurality of electric wires,
at least one electric wire of the plurality of electric wires being an aluminum electric wire including a conductor core wire formed from pure aluminum or an aluminum alloy,
the aluminum electric wire being covered with a foamed body, the foamed body having a thermal conductivity of 0.034 W/m·K or less.

2. (canceled)

3. The wire harness according to claim 1, wherein the foamed body has a thickness from 2 mm to 6 mm.

4. The wire harness according to claim 3, wherein the foamed body has a thickness from 2 mm to 5 mm.

5. The wire harness according to claim 3, wherein the foamed body has a thickness more than 5 mm and not more than 6 mm.

6. The wire harness according to claim 1, wherein the foamed body is made from foamed polyvinyl chloride when the aluminum electric wire includes an insulator made from polyvinyl chloride, and the foamed body is made from foamed polyethylene when the aluminum electric wire includes the insulator made from polypropylene.

7. The wire harness according to claim 1, wherein the foamed body has a layer structure including at least one layer of a closed cell structure having its internal cells being independent of one another.
